(19) United States
(12) Patent Application Publication
(10) Pub. No.: US 2009/0216734 A1
(43) Pub. Date: Aug. 27, 2009

(54) SEARCH BASED ON DOCUMENT ASSOCIATIONS

(75) Inventors: Suren Aghajanyan, Bellevue, WA (US); Craig Anthony Osborne, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/035,408

(22) Filed: Feb. 21, 2008

(51) Int. Cl. G06F 7/06

(52) U.S. Cl. 707/5; 707/E17.014

(57) ABSTRACT

A method and a processing device are provided. A group of documents may be selected from multiple documents of a search result. Associations among the selected group of documents may be determined and indicated. An indication of ones of the associations that are of interest and/or others of the associations that are of no interest may be received. A new search result may be presented, including one or more documents satisfying some or all of the associations of interest and none of the associations of no interest. In some embodiments, a document may be selected from a search result and characteristics of the document may be determined. A search result may be presented, which may include one or more documents having none or some of the characteristics of the selected document. A visual indication of a strength of an association of a document may be provided.

### BACKGROUND

An electronically stored document may be a digital photo, text, a combination of one or more digital photos and text, or other information. When searching for a desired document, a user, typically, may provide one or more keywords, which may be included in the desired document or in associated metadata. To find the desired document, the one or more user-provided keywords may be an exact match, with respect to the keywords included in the desired document or in the associated metadata. However, if the user cannot remember which keywords to use, or the user incorrectly spells the keywords, searching for the desired document may become difficult and frustrating.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a processing device may be provided for searching among a number of documents for a desired document based on document associations. In one embodiment, an initial search may be performed based on one or more user-provided keywords. As a result, a search result, which may include multiple documents, may be displayed to a user. The user may select a group of documents from the multiple documents, resulting in an indication of one or more associations in common among the selected group of documents. The user may indicate ones of the associations that are of interest and/or others of the associations that are of no interest. A new search may be performed and a new search result may be presented having one or more documents satisfying some or all of the associations of interest and none of the associations of no interest.

In some embodiments, the user may select a seed document from a search result and may request a search for similar or dissimilar documents. Characteristics of the seed document may be analyzed and a search result may be presented including one or more documents having at least one of the characteristics of the seed document (when a search for similar documents is performed), or a search result may be presented including one or more documents lacking one or more of the characteristics of the seed document (when a search for dissimilar documents is performed). In the presented search result, the one or more documents may be presented as islands, such that ones of the documents having a strong association with the seed document may appear visually different than others of the documents having a weak association with the selected document.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment for some embodiments consistent with the subject matter of this disclosure.

FIG. 2 illustrates a functional block diagram of an exemplary processing device, which may implement embodiments consistent with subject matter of this disclosure.

FIG. 3 illustrates an exemplary document model for conducting a search in embodiments consistent with the subject matter of this disclosure.

FIG. 4 is a flowchart of an exemplary process for performing a search based on document associations.

FIG. 5 is a flowchart of another exemplary process for performing a search based on document associations.

FIG. 6 illustrates an exemplary display of a search result, in which a strength of an association may be visually indicated.

FIG. 7 illustrates an exemplary display showing relationships among different groups of documents.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and a processing device for performing a document search for a desired document based upon document associations. An initial search may be performed based upon, for example, one or more user-provided keywords. A search result may then be presented to a user. The search result may include multiple documents, which may include the one or more user-provided keywords.

The user may view one or more of the documents of the search result and may decide that a group of the documents are similar to the desired document. The user may select the group of the documents and an indication of one or more associations in common among the selected group of documents may be presented. The user may select ones of the associations that are of interest and/or others of the associations that are of no interest. A new search may be performed and a new search result, including one or more documents, may be presented to the user. The one or more documents may satisfy some or all of the selected ones of the association that are of interest and may not satisfy any of the others of the associations that are of no interest.

The user may select ones of the one or more documents of the new search result to repeat a process of discovering associations and finding documents satisfying selected associations of interest and not satisfying selected associations of no interest until the desired document is found.

In some embodiments, the user may select a document of a search result as a seed document and may indicate a desire to find similar or dissimilar documents. The processing device may analyze characteristics of the seed document and may display a search result including one or more found similar or dissimilar documents. A visual indication may be provided to indicate a strength of an association that a found document has with the seed document. The strength of the association may be based on a number of characteristics the found document shares with the seed document.

### Exemplary Operating Environment

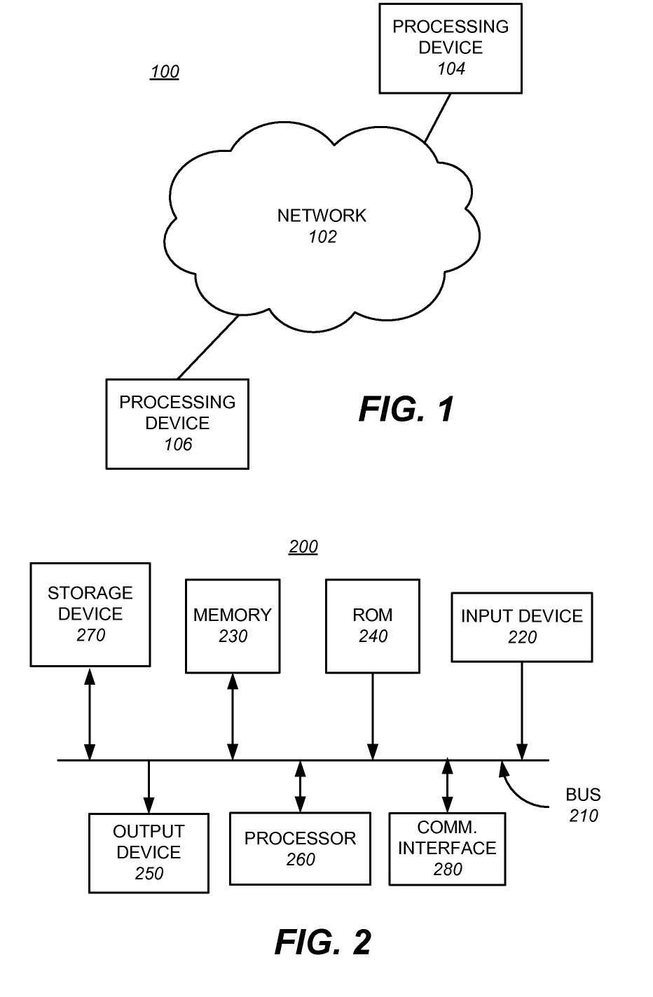

FIG. 1 illustrates an exemplary operating environment 100 in which some embodiments consistent with the subject matter of this disclosure may operate. Exemplary operating environment 100 may include multiple processing devices 104, 106, which may communicate with each other via a network 102.

Network 102 may be a single network or a combination of networks, such as, for example, the Internet or other networks. Network 102 may include a wireless network, a wired network, a packet-switching network, a public switched telecommunications network, a fiber-optic network, other types of networks, or any combination of the above.

In one embodiment, processing device 106 may be a user's processing device and processing device 104 may be a server or a server farm providing a network service. Processing device 106 may include a browser, or other application, for permitting a user to communicate with processing device 104.

The user may request a search for a desired document via processing device 106. Processing device 104 may receive the request, perform a search, and return search results to processing device 106, which may display the search results on a display screen.

Alternatively, processing device 106 may be a stand-alone embodiment consistent with the subject matter of this disclosure. That is, a user may enter a search request to processing device 106, processing device 106 may perform the search and may display a search result, including one or more documents, via a display of processing device 106.

### Exemplary Processing Device

FIG. 2 is a functional block diagram of an exemplary processing device 200, which may be used to implement processing device 104 and/or processing device 106 in embodiments consistent with the subject matter of this disclosure. Processing device 200 may be a desktop personal computer (PC), a laptop PC, a handheld processing device, a server, a server farm, or other processing device. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include compact disc (CD), digital video disc (DVD), a magnetic medium, or other type of storage device for storing data and/or instructions for processor 260.

Input device 220 may include a keyboard, a pointing device or other input device. Output device 250 may include one or more conventional mechanisms that output information, including one or more display monitors, or other output devices. Communication interface 280 may include a transceiver for communicating via one or more networks via a wired, wireless, fiber optic, or other connection.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

### Exemplary Document Model

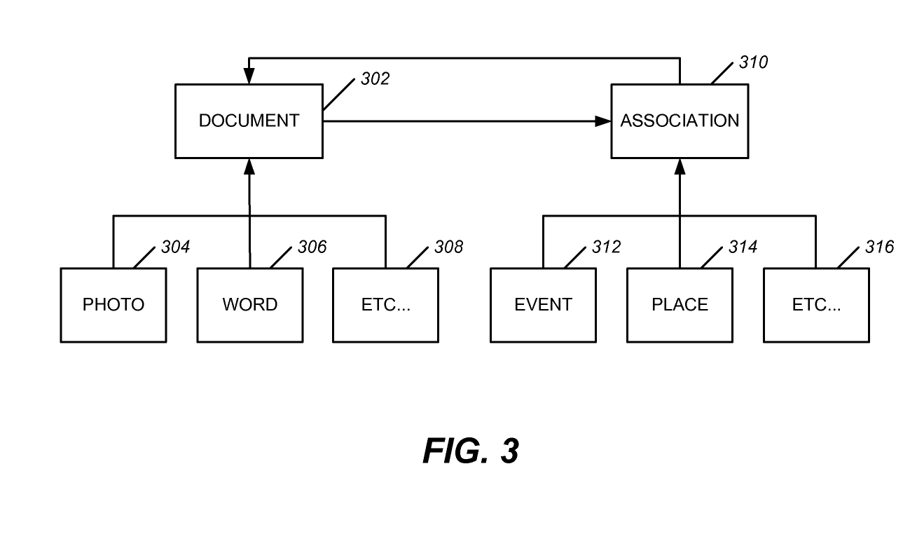

FIG. 3 illustrates an exemplary document model for conducting a search in embodiments consistent with the subject matter of this disclosure. Document 302 may include a digital photo 304, words 306, and/or other items 308. Document 302 may be related to one or more other documents via an association 3 10. Association 310 may be based on an event 312, a place 314, or other item 316.

For sake of an example, assume that document 302 is a digital photo. A first digital photo may include metadata indicating an event, such as, for example, “Joe's birthday”. Other digital photos may include metadata indicating that the digital photos include beaches. The first digital photo may be associated with the other digital photos, including beaches, because the first digital photo may be a photo taken at Joe's birthday party at a beach. Further, the first digital photo may also be associated with other digital photos of Joe's birthday taken at other locations.

### Exemplary Processes

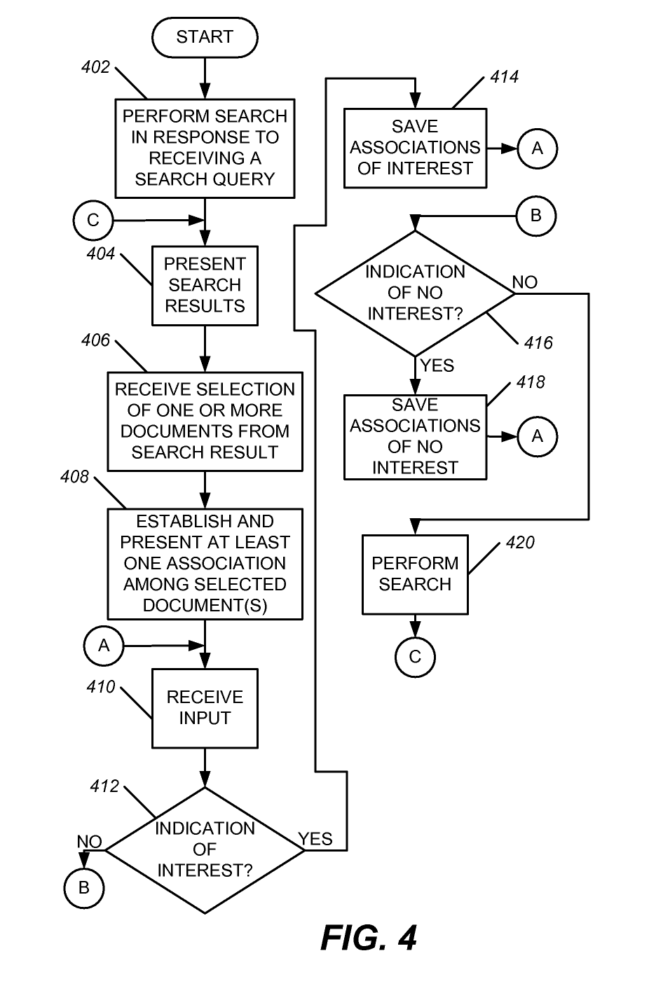

FIG. 4 is a flowchart illustrating an exemplary process, which may be performed in embodiments consistent with the subject matter of this disclosure, for performing a search based upon document associations. The process may begin with a processing device performing a search in response to receiving a search query (act 402). The search may be based upon one or more keywords included with the received search query. The processing device may provide a search result, which may be displayed to a user (act 404). The search result may include a representation of one or more documents.

In a standalone embodiment, the processing device may receive the search query as input from a user and may present a search result via an output device of the processing device, such as, for example, a display screen, or other output device. In an embodiment executing in an operating environment, such as, for example, exemplary operating environment 100, the processing device may receive a search query from a second processing device via a network, may perform a search, and may provide a search result to the second processing device via the network. The second processing device may present the search result via an output device, such as, for example, a display screen, or other output device.

The processing device may receive a selection of at least one document from the search result (act 406). The processing device may then establish and present at least one association with respect to the at least one selected document (act 408). For example, if the user selected a group of documents, the processing device may determine one or more associations in common among the selected group of documents and may present, or display, an indication of the one or more associations in common. Thus, if the selected group of documents are digital photos of beaches, as may be determined by metadata of each respective digital photo, or via other means, the processing device may present an indication that the selected group of digital photos are associated with beaches. Other associations may also be indicated. For example, if the selected group of digital photos were taken during a same time period, such as, for example, July 2006, the processing device may present an indication that the selected group of digital photos are associated with July of 2006.

If, during act 406, the processing device received a selection of only one document from the search result, then during act 408, the processing device may determine a number of characteristics, with respect to the document, via metadata associated with the document, or via other means. For example, if a single digital photo document is selected, then, during act 408, the processing device may display characteristics, such as, for example, “beach photo”, “taken July 2006”, and/or other characteristic, which may be treated as associations.

The processing device may then receive an input (act 410). The processing device may determine whether the received input is an indication of interest with respect to one or more of the displayed associations (act 412). If the received input is an indication of interest, then the processing device may save the associations of interest (act 414) and act 410 may be repeated. An indication of interest, with respect to one or more of the associations, may indicate to the processing device a desire to find documents having the one or more of the associations.

If, during act 412, the processing device determines that the received input is not an indication of interest, then the processing device may determine whether the received input is an indication of no interest with respect to one or more of the displayed associations (act 416). If the received input is an indication of no interest, then the processing device may save the associations of no interest (act 418) and act 410 may be repeated. An indication of no interest, with respect to one or more of the associations, may indicate to the processing device a desire to find documents not having the one or more of the associations.

As an example of how an indication of interest and an indication of no interest may be used, in an embodiment consistent with the subject matter of this disclosure, assume that documents represented in a search result are digital photos associated with “Joe's birthday”. A selection of a group of the digital photos may cause the processing device to display associations in common among the selected group of digital photos, such as, for example, “beach photos”, “Joe's birthday”, and “July 2006 photos”. The processing device may receive an indication of interest with respect to “Joe's birthday” and “July 2006 photos” and an indication of no interest with respect to “beach photos”. The processing device may then perform a search and present digital photos that satisfy the associations “Joe's birthday” and “July 2006 photos” and that do not satisfy the association “beach photos”.

If, during act 416, the processing device determines that the received input is not an indication of no interest, then the processing device may assume that the received input is a command to perform a search. Therefore, the processing device may perform a search (act 420) after determining that the received input is not an indication of no interest. The processing device may then repeat act 404 and present a new search result.

The exemplary process of FIG. 4 may be repeated until one or more desired documents are found. At any time during a search process, the user may abort and restart the search process.

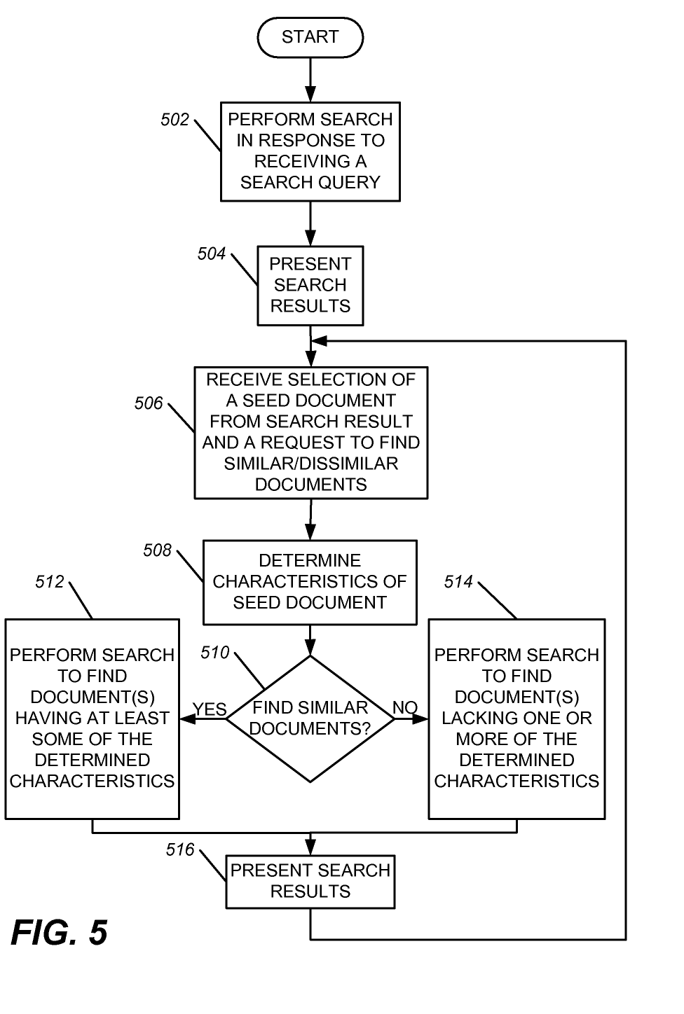

FIG. 5 is a flowchart illustrating another exemplary process, which may be performed in embodiments consistent with the subject matter of this disclosure, for performing a search based upon document associations. The process may begin with a processing device performing a search in response to receiving a search query (act 502). The search may be based upon one or more keywords included with the received search query. The processing device may present a search result, which may be displayed to a user (act 504). The search result may include a representation of one or more documents.

Next, the processing device may receive a selection of a document from among the one or more documents of the search result to be used as a seed document, along with a request to find either similar documents or dissimilar documents (act 506). The processing device may then determine a number of characteristics, with respect to the seed document, via metadata associated with the seed document, or via other means. (act 508).

The processing device may then determine whether the received request was for searching for documents similar to the seed document (act 510). If the processing device determines that the received request was for searching for documents similar to the seed document, then The processing device may perform a search to find one or more documents having at least some of the determined characteristics (act 512). Otherwise, the processing device may assume that the received request was for searching for documents dissimilar to the seed document and the processing device may perform a search to find one or more documents lacking one or more of the determined characteristics (act 514). The processing device may present search results including a representation of at least one document having at least some of the determined characteristics (if a search was performed for similar documents), or the processing device may present search results including a representation of at least one document lacking one or more of the determined characteristics (if a search was performed for dissimilar documents) (act 516). The processing device may then repeat act 506-514 until a desired document is found.

Similarity or dissimilarity may be a generic measure of belonging to, or not belonging to, a certain group, respectively. In some embodiments, similarity or dissimilarity may be determined probabilistically or via fuzzy logic.

The processes illustrated by FIGS. 4 and 5 are exemplary and may be implemented in different embodiments, or may be combined in one embodiment, such that, for example, a user may request a search for a document by selecting one or more documents of a presented search result, viewing associations with respect to the selected one or more documents, and selecting associations of interest and/or associations of no interest, or the user may select a document from the presented search result and may request a search for either similar documents or dissimilar documents.

### Establishing Associations Among Documents

In embodiments consistent with the subject matter of this disclosure, some associations among documents may be established automatically and other associations among the documents may be established manually. The processing device may automatically examine a number of characteristics of a group of documents in an attempt to automatically establish one or more associations. Again, using an example in which documents are digital photos, the processing device may attempt to find an association in common among a group of digital photos by, for example, looking for common words in metadata associated with the digital photos, determining whether the group of digital photos were taken within a particular time period, such as, a day, a week, a month, or other time period, determining whether the group of digital photos were taken at a same location (by analyzing metadata associated with respect to the digital photos, analyzing Global Positioning System (GPS) data stored with the digital photos, or via another means), determining a feature of digital photos, such as, for example, whether a particular person, or group of people are included in the digital photos (by using a facial recognition system, or other means), or determining other associations by examining other data associated with a group of digital photos.

In one embodiment, an association may be established manually among a group of documents. Referring to an example, in which a group of documents may be digital photos, a collection may be defined to have a name, such as, for example, “2006 summer vacation”. A collection may be a user-defined reference to one or more documents. The user may include a number of documents, such as, digital photos, in the collection named “2006 summer vacation”. Documents may be included in multiple collections. When the processing device attempts to establish an association in common among a group of documents, the processing device may examine any defined collections to determine whether the group of documents are included in a same collection. If the group of documents are determined to be in the same collection, such as, for example, the collection named “2006 summer vacation”, the processing device may display an indication that “2006 summer vacation” is an association in common among the group of documents.

### Exemplary Displays

In some embodiments consistent with the subject matter of this disclosure, search results may be presented in such a way as to indicate a strength of an association or other relationship. For example, as discussed with respect to the exemplary process illustrated by FIG. 5, a user may select a document from a search result as a seed document and may provide an indication that the user wishes to find either similar documents or dissimilar documents. The processing device may then display a search result including a centrally located representation of the seed document and representations of the found documents, such that displayed representations may provide a visual indication regarding a strength of an association with the selected document. A strong association with the selected document may be determined based on a number of characteristics in common with the seed document, or via another criteria. For example, if the search was intended to find similar documents, then a strong association may be determined when a document has a larger number of characteristics in common with the seed document(s). If the search was intended to find dissimilar documents, then a strong association may be determined when a document lacks a larger number of characteristics in common with the seed document(s).

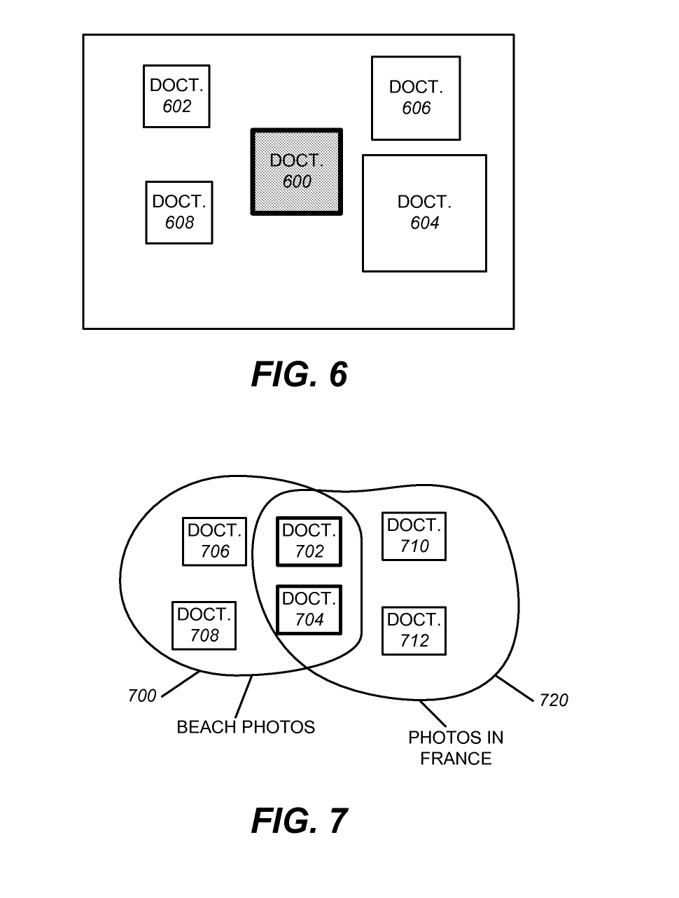

FIG. 6 illustrates an exemplary display in which a representation of documents having a stronger association with the seed document are displayed in a larger size. FIG. 6 shows a representation of a seed document 600 being centrally located in the display with a visual indication for informing a user of the seed document(s). In the exemplary display of FIG. 6, seed document 600 is visually indicated by a dark border and shading. In other embodiments, any number and type of visual indications may inform the user of the seed document.

In FIG. 6, document 604 may have a strongest association with seed document 600, followed by document 606. Documents 602 and 608 may have a same strength of association with the selected document. In FIG. 6, the displayed representations of documents may be referred to as islands. In other embodiments, documents may be represented by other means.

Of course, other visual indications may be provided, such as, for example, displaying representations of documents using different colors. For example, one color may indicate a very strong association with the selected document, another color may indicate a week association with the selected document, and a third color may indicate an extremely weak or no association with the selected document. In other embodiments other visual indications, such as, for example, size, brightness, distance, order, as well as other visual indications, may indicate relevance and strength of an association with the selected document. Other visual indications, such as, for example, color, grouping/clustering, and opacity may indicate certain relationships. The above examples of visual indications are merely exemplary and are not intended to limit types of visual indications or types of relationships indicated by the visual indications.

In some embodiments, in response to receiving a request to present documents included in a group or collection, the processing device may display a representation of documents included in the group or collection. A user may request to see a relationship between one group or collection and one or more other groups or collections. For example, assuming that the documents are digital images, a group of digital images belonging to a collection called “beach photos” may be presented on a display screen of the processing device. The user may request to view information with respect to how the collection called “beach photos” may be related to other collections. As a result of receiving the request, the processing device may display a representation of the digital photos included in the collection named “beach photos”, and a representation of digital photos included in one or more other collections having some relationship to the collection named “beach photos”.

FIG. 7 illustrates an exemplary display showing documents 702, 704, 706, 708 belonging to a collection 700 named “beach photos”. The exemplary display also shows documents 702, 704, 710, 712 belonging to a collection 720 named “photos in France”. As shown in FIG. 7, an indication, with respect to which documents are included in which groups, may be provided. In FIG. 7, the indication includes lines encircling documents included in respective groups. As one can easily determine from viewing the exemplary display of FIG. 7, documents 702, 704 are included in collection 700, as well as in collection 720. In various embodiments, more than two collections and relationships to other collections may be displayed. For example, with reference to FIG. 7, other collections related to either collection 720 or collection 700 may also be displayed.

### Miscellaneous

In the examples mentioned above, the documents are assumed to be digital photos. This was done for the sake of illustrating simple examples. Thus, in embodiments consistent with the subject matter of this disclosure, documents are not limited only to being digital photos. For example, documents may include text, audio, presentations, video, or other information. Further, different types of associations may be established in other embodiments. For example, in an embodiment performing a search on textual documents, associations may be established based on certain words, phrases, or other information appearing in textual documents.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the invention, rather than any specific examples given.

We claim as our invention:

1. A machine-implemented method for searching for a document, the machine-implemented method comprising:
receiving a selection of at least one first document from a presented search result;
establishing and presenting at least one association with respect to the at least one first selected document;
receiving either an indication of interest with respect to at least one of the at least one association or receiving an indication of no interest with respect to the at least one of the at least one association; and
presenting either a next search result including at least one second document having the at least one of the at least one association corresponding to the indication of interest when the indication of interest is received, or presenting the next search result including the at least one second document not having the at least one of the at least one association corresponding to the indication of no interest when the indication of no interest is received.

2. The machine-implemented method of claim 1, wherein associations are based on document metadata.

3. The machine-implemented method of claim 1, wherein documents presented in the search results are digital photos.

4. The machine-implemented method of claim 1, further comprising:
permitting manual associations among a plurality of documents to be established.

5. The machine-implemented method of claim 1, further comprising:
automatically establishing associations among a plurality of documents.

6. The machine-implemented method of claim 1, further comprising:
receiving a request to find a document similar to, or dissimilar with respect to a seed document selected from a last presented search result; and
presenting a new next search result as a plurality of islands, each of the plurality of islands representing a respective one of a plurality of documents, a size of respective ones of the plurality of islands corresponding to a strength of an association of a corresponding one of the plurality of documents with the seed document.

7. The machine-implemented method of claim 1, further comprising:
graphically indicating associations between at least two groups of documents.

8. A processing device comprising:
at least one processor; and
a memory connected to the at least one processor, the memory including instructions for the at least one processor, the instructions comprising:
instructions for providing a first search result including a first plurality of documents, the first search result being provided in response to receiving a first search query,
instructions for receiving a selection of at least one document of the first plurality of documents,
instructions for providing at least one association in common among the selected at least one document,
instructions for receiving a selection of at least one of the at least one association in common,
instructions for receiving an indication of interest or receiving an indication of no interest with respect to the selected at least one of the at least one association in common,
instructions for providing a second search result of second documents having the selected at least one of the at least one association in common when an indication of interest is received, and
instructions for providing the second search result of second documents not having the selected at least one of the at least one association in common when an indication of no interest is received.

9. The processing device of claim 8, wherein documents provided in search results are digital photos.

10. The processing device of claim 8, wherein the instructions further comprise:
instructions for receiving a request to find a document similar to, or dissimilar from, a seed document selected from a last presented search result; and
instructions for presenting a new next search result as a plurality of islands, each of the plurality of islands representing a respective one of a plurality of documents, a color of respective ones of the plurality of islands corresponding to a strength of an association of a corresponding one of the plurality of documents with the seed document selected from the last presented search result.

11. The processing device of claim 8, wherein some associations among a plurality of documents are automatically established and other associations among the plurality of documents are manually established.

12. The processing device of claim 8, wherein the instructions further comprise:
instructions for establishing associations among documents based on corresponding document metadata and based on one or more collections to which respective documents belong.

13. The processing device of claim 8, wherein:
documents included in search results are digital photos, and the instructions further comprise:
instructions for establishing associations among a plurality of documents based on one or more features of the digital photos.

14. A machine-implemented method for searching for a document, the machine-implemented method comprising:
providing a first search result, based on at least one provided keyword, the first search result including a plurality of documents;
receiving a selection of one of the plurality of documents of the first search result and a request to find similar documents;
determining characteristics of the selected one of the plurality of documents;
performing a search to find at least one document having at least some of the determined characteristics of the selected one of the plurality of documents; and
presenting a second search result including the at least one document having at least some of the determined characteristics of the selected one of the plurality of documents.

15. The machine-implemented method of claim 14, further comprising:
receiving a selection of at least one of a plurality of documents of a third search result;
determining and presenting all associations common to the received selection of the at least one of the plurality of documents of the third search result;
receiving at least one indication with respect to ones of the associations that are of interest and others of the associations that are not of interest; and
providing a fourth search result including a plurality of documents, each of the plurality of documents of the fourth search result having at least one association of the associations that are of interest and none of the associations of the associations that are not of interest.

16. The machine-implemented method of claim 15, further comprising:
establishing at least some of the associations automatically.

17. The machine-implemented method of claim 15, further comprising:
establishing at least some of the associations manually.

18. The machine-implemented method of claim 15, further comprising:
manually establishing at least some of the associations by establishing respective documents as part of one or more collections.

19. The machine-implemented method of claim 15, further comprising:
graphically presenting the second search result, a strength of an association of respective documents of the second search result with the selected one of the plurality of documents of the first search result being visually indicated.

20. The machine-implemented method of claim 15, wherein each of the plurality of documents is a digital photo.
